(19) United States
(12) Patent Application Publication
(10) Pub. No.: US 2026/0346668 A1
(43) Pub. Date: Nov. 5, 2026

(54) Spring Assembly for a Vehicle

(71) Applicant: Hasse & Wrede GmbH, Berlin (DE)

(72) Inventors: Sebastian WILLEKE, Hoppegarten (DE); Michael STEIDL, Berlin (DE); Stephan BOHMEYER, Hoppegarten (DE); Norbert REINSPERGER, Hoppegarten (DE)

(21) Appl. No.: 19/486,764

(22) PCT Filed: May 8, 2024
(86) PCT No.: PCT/EP2024/062765

§ 371 Date: Nov. 21, 2025

(30) Foreign Application Priority Data
May 24, 2023 (DE) 10 2023 113 608.9

(51) Int. Cl. B60G 11/00; B60G 3/00; B62D 21/11

(52) U.S. Cl. CPC B60G 11/00; B60G 3/00; B62D 21/11; B60G 2200/10; B60G 2204/12

(57) ABSTRACT

A spring assembly for a vehicle, more particularly a utility vehicle, has at least a first spring and at least a second spring that are arranged connected in parallel. The spring assembly is a non-linear spring assembly with a progressive load deflection curve. A strut having a spring assembly of this type is provided.

### BACKGROUND AND SUMMARY

The present invention relates to a spring assembly for a vehicle, in particular a utility vehicle. The invention also relates to a suspension strut of a vehicle, in particular a utility vehicle, having such a spring assembly.

In the current prior art, spring assemblies/suspension arrangements of utility vehicles are provided predominantly using air springs. Here, compressed air is provided by a compressor that has to be carried on board the vehicle. The suspension action is based on the compressibility of the compressed air in the spring bellows. The spring stiffness can be adapted to the loading condition of the vehicle through variation of the air pressure. Furthermore, the adaptation of the air pressure allows regulation of the vehicle ride height.

During driving operation of a vehicle, the suspension arrangement has the task of ensuring a constant natural frequency of the vehicle, which is subjected to static and dynamic loading. This requires the stiffness of the suspension arrangement to be adapted in accordance with the vehicle mass and the loading condition of the vehicle.

The suspension arrangement forms, together with the vehicle, an oscillatory system that is excited by external forces to perform oscillations. The vehicle has a natural frequency depending on its weight and the payload. The excitation is caused, during travel, by unevennesses in the roadway, by wind loads and by changes in the driving condition (for example acceleration, deceleration, cornering).

A disadvantage of suspension arrangements having a linear spring characteristic curve is that their constant spring stiffness results in natural frequencies which differ depending on the payload of the utility vehicle. Conventional air suspension arrangements therefore allow adaptation of the spring stiffness to the loading condition through variation of the air pressure, but for this purpose require numerous compressed-air supply components, including the peripheral components thereof (for example compressor, air dryer, compressed-air accumulator, pressure controller and sensors, and control electronics), to be carried on board. A major aspect that has hitherto justified this additional outlay is the fact that the compressed air can commonly also be used for other purposes (for example compressed-air brakes).

However, against the background of the increasing electrification of utility vehicles, alternative brake concepts (for example electric brakes) are gaining in importance, such that carrying compressed-air assemblies for use solely by the air suspension arrangement appears to no longer be justified.

The invention is therefore based on the object of creating a suspension arrangement/spring assembly in particular taking into account the vehicle dynamics, wherein the aforementioned disadvantages no longer arise or are significantly reduced.

This and other objects are achieved by means of a spring assembly and also by means of a suspension strut having the features of the independent claim(s).

The present invention provides a concept for the suspension of utility vehicles. It satisfies the vehicle dynamic requirement for an approximately constant natural frequency independently of the vehicle payload.

Accordingly, a spring assembly according to the invention for a vehicle, in particular a utility vehicle, comprises at least one first spring and at least one second spring which are arranged in a parallel configuration. The spring assembly is designed as a non-linear spring assembly having a progressive spring characteristic curve.

A particular advantage here is that the suspension arrangement has a non-linear or progressive characteristic curve. Proceeding from a low stiffness level in the unloaded condition, the spring stiffness increases with increasing payload of the vehicle or with increasing compression of the springs. The progressive rise of the spring characteristic curve thus compensates for the influence of the increasing vehicle mass, resulting in an approximately constant level of the vehicle natural frequency.

By contrast, when a conventional suspension arrangement having a linear spring characteristic curve or constant stiffness is used, the natural frequency decreases significantly with increasing vehicle mass. The non-linear spring concept thus offers the advantage of a natural frequency that is virtually independent of payload. It is also a passive suspension concept, by contrast to air suspension, which requires active control for the purposes of adapting the air pressure and the stiffness to the load condition.

A suspension strut of a vehicle, in particular utility vehicle, having a spring assembly, a frame and a plate that is guided movably in the frame, has the spring assembly described above.

In one embodiment, the spring assembly is arranged in a frame which is movable in the translation direction along a deflection relative to a plate, wherein the plate is guided in the frame so as to be movable in the translation direction. This results in an advantageously compact construction.

A further embodiment provides that the at least one first spring of the spring assembly has at least one spring element, and that the at least one second spring has two spring elements. An advantage of this is easy adaptability to different usage situations.

It is advantageous if the at least one first spring of the spring assembly has a constant spring stiffness, and the at least one second spring has a non-linear spring stiffness, because it is thus possible for the two spring types to be dimensioned and arranged independently of one another for the purposes of adaptation to different usage situations.

In one embodiment, the at least one second spring having the non-linear spring stiffness may have regions with and without a negative stiffness. In this way, the stiffness of the at least one second spring can change from negative to positive depending on the loading condition, and thus advantageously generate a non-linear characteristic curve. Such a spring assembly may thus be formed as a linear spring in combination with at least one non-linear spring element.

In a yet further embodiment, the at least one spring element of the at least one first spring having the constant spring stiffness is articulated on the frame, wherein the other spring end of the spring element is attached to the plate. This construction is advantageously simple.

Another embodiment provides that the at least one second spring having the non-linear spring stiffness is constructed from two spring elements which are arranged as a pair and so as to be inclined with respect to a translation direction extending in the direction of gravitational acceleration. This therefore yields an advantageously simple construction.

In a further embodiment, a first end of the first spring element of the at least one second spring is fastened to a projection protruding from an inner top wall of the frame, wherein a first end of the second spring element of the at least one second spring is articulated on an inner side wall of the frame, wherein the two spring elements of the at least one second spring are articulated, by way of their other spring ends brought together at a common articulation point, on the plate. This makes a compact and simple construction possible.

Further advantageous embodiments of the invention are apparent from the dependent claims.

In one embodiment, the common articulation point of the other spring ends of the two spring elements of the at least one second spring is attached to a projection protruding from the plate. This construction has the advantage of a space-saving design.

A further embodiment provides that the first spring ends of the spring elements of the at least one second spring lie in a common plane, wherein said plane extends at right angles to the translation direction. An advantage here is that a simple arrangement of the spring elements for forming the non-linear spring is possible.

One embodiment of the suspension strut provides that the frame is connected to a chassis of an associated vehicle, and that the plate is fastened to a wheel suspension of a vehicle wheel of the associated vehicle. This is advantageous for quick installation and uninstallation both during the assembly process and during repair and maintenance work.

If the plate is guided in the frame so as to be movable in a translation direction, wherein the translation direction extends along a deflection in the direction of gravitational acceleration, a simple construction is advantageously achieved.

An exemplary embodiment of the invention will be described below on the basis of the appended drawings. The invention is not restricted to this exemplary embodiment. In particular, individual features of the following exemplary embodiments may be used not only in these but also in other exemplary embodiments.

### BRIEF DESCRIPTION OF THE DRAWINGS

FIGS. 1-2: are schematic illustrations of an exemplary embodiment of a suspension assembly of a vehicle in different load conditions;

FIGS. 3-5: are symbolic illustrations of a suspension assembly of the exemplary embodiment in the different load conditions according to FIGS. 1 and 2; and

FIGS. 6-7: are diagrams showing spring characteristic curves of the exemplary embodiment according to FIGS. 1-3.

Below, expressions such as “top” or “bottom” relate to the plane of the drawing in question.

### DETAILED DESCRIPTION OF THE DRAWINGS

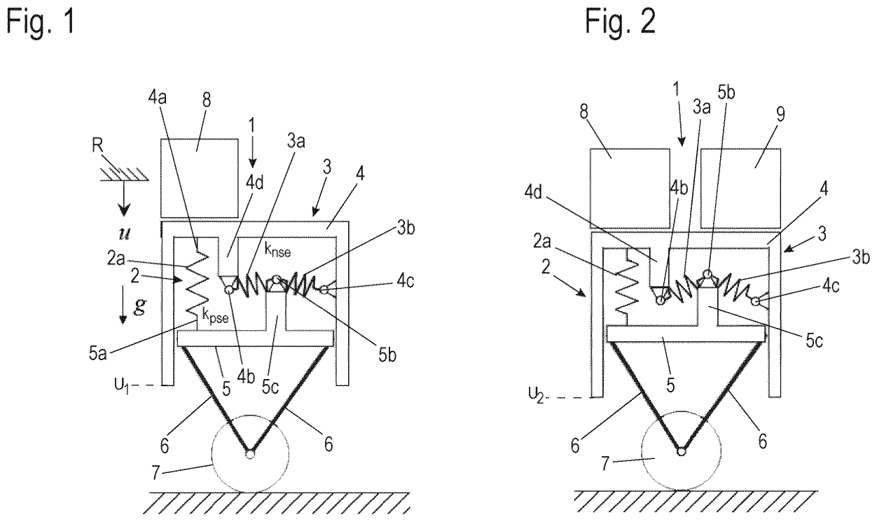

FIG. 1 is a diagrammatic illustration of an exemplary embodiment of a suspension assembly 1 according to the invention of a vehicle in a load condition in which loading is applied by a chassis 8 of the vehicle.

FIG. 2 shows the suspension assembly 1 of the exemplary embodiment according to FIG. 1 in a load condition involving the chassis and an additional load 9.

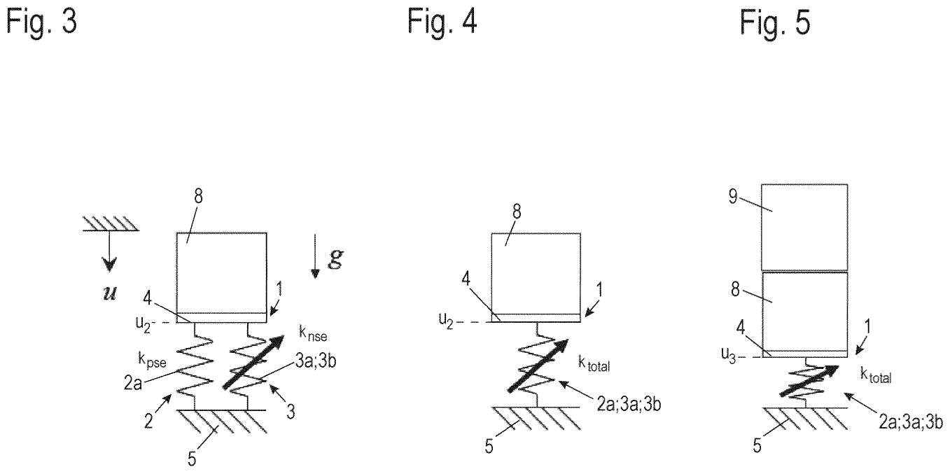

FIGS. 3-5 are symbolic illustrations of the spring assembly 1 of the exemplary embodiment in the different load conditions according to FIGS. 1 and 2.

FIGS. 1-2 show a spring assembly 1 in two different loading or load conditions.

The spring assembly 1 is designed as a non-linear spring assembly and comprises a first spring 2 having a constant spring stiffness k_{PSE} and a second spring 3 having a non-linear spring stiffness k_{NSE}. The first spring 2 has one spring element 2a, wherein the second spring 3 is configured with two spring elements 3a and 3b.

The first spring 2 having the constant spring stiffness k_{PSE} and the second spring 3 having the non-linear spring stiffness k_{NSE} are arranged in a parallel configuration.

The spring element 2a of the first spring 2 having the constant spring stiffness k_{PSE} is articulated, by way of a first spring end, on an inner top wall of the frame 4 at a first frame articulation 4a, wherein the other spring end of the spring element 2a of the first spring 2 having the constant spring stiffness k_{PSE} is attached to the plate 5 at a first plate articulation 5a.

The second spring 3 having the non-linear spring stiffness k_{NSE} is constructed from two spring elements 3a and 3b which are arranged as a pair and so as to be inclined with respect to the translation direction u.

A first end of the first spring element 3a of the second spring 3 is fastened, at a second frame articulation 4b, to a projection 4d of the inner top wall of the frame 4, wherein a first end of the second spring element 3b of the second spring 3 is articulated, at a third frame articulation 4c, on an inner side wall of the frame 4. The second frame articulation 4b and the third frame articulation 4c have an identical position value u in the translation direction relative to a common base, which is indicated here as reference R. In other words, the second frame articulation 4b and the third frame articulation 4c lie in a common plane. Said plane extends at right angles to the translation direction.

Here, the two spring elements 3a, 3b of the second spring 3 are articulated, by way of their other spring ends brought together at a common articulation point at a second plate articulation 5b, on the plate 5. The second plate articulation Sb is situated on a projection 5c protruding inward, that is to say into the frame 4, from the plate 5.

In an unloaded load condition of the spring assembly 1, which is not shown here but is contemplated, the springs 2 and 3, that is to say the spring elements 2a, 3a, 3b thereof, are fully relaxed.

If the spring assembly 1 is loaded with the weight of the chassis 8 of the associated vehicle, the frame 4 is adjusted beyond the plate 5 such that the plate 5 is situated approximately in a lower quarter of the frame 4. This is schematically indicated in FIG. 1. Here, the frame 4 has been adjusted such that its bottom edge assumes a first position w. The value of the first position m is greater, in relation to the reference R, than a value in the unloaded load condition.

In this load condition according to FIG. 1, the spring assembly 1 is statically preloaded by the mass of the chassis 8. Here, the non-linear stiffness of the second spring 3 having the spring elements 3a, 3b is at its minimum absolute value.

FIG. 2 shows the statically preloaded spring assembly 1 under loading applied by the mass of the chassis 8 and additionally by a payload 9, in which situation the first spring 2 and the second spring 3 each have positive stiffnesses.

Here, the bottom edge of the frame 4 is in a second position u₂ having a value greater than u₁. The plate 5 is situated in the frame 4 approximately at the level of the middle of a side, wherein the middle of a side is at approximately half of the length of the inner side of the frame 4 in the translation direction u.

FIGS. 3-5 show symbolic illustrations of the spring assembly 1 of the exemplary embodiment in the different load conditions according to FIGS. 1 and 2, with the associated values of the positions u₁ and u₂ of the frame 4.

The frame 4 is only partially indicated. FIG. 3 shows the spring assembly 1 by way of symbols for the first spring 2 and the second spring 3.

The spring assembly 1 comprises the first spring 2 having the spring element 2a having a constant spring stiffness k_{PSE} and comprises the second spring 3 consisting of the spring elements 9a and 9b having a non-linear spring stiffness k_{NSE}. The spring assembly 1 is arranged between the frame 4 and the plate 5, as already described above.

The parallel configuration of the first spring 2 (k_{PSE}) and the second spring 3 (k_{NSE}) results in an overall spring stiffness kₜₒₜₐₗ as illustrated in simplified form in FIG. 4 using only one spring symbol.

FIG. 5 symbolically illustrates the spring assembly 1 having the overall spring stiffness total in the load condition involving chassis 8 and payload 9, according to FIG. 2.

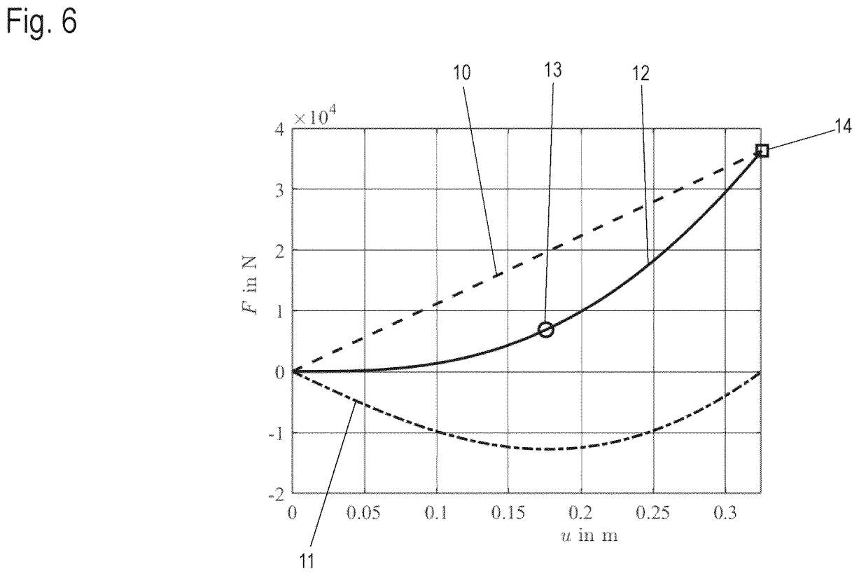

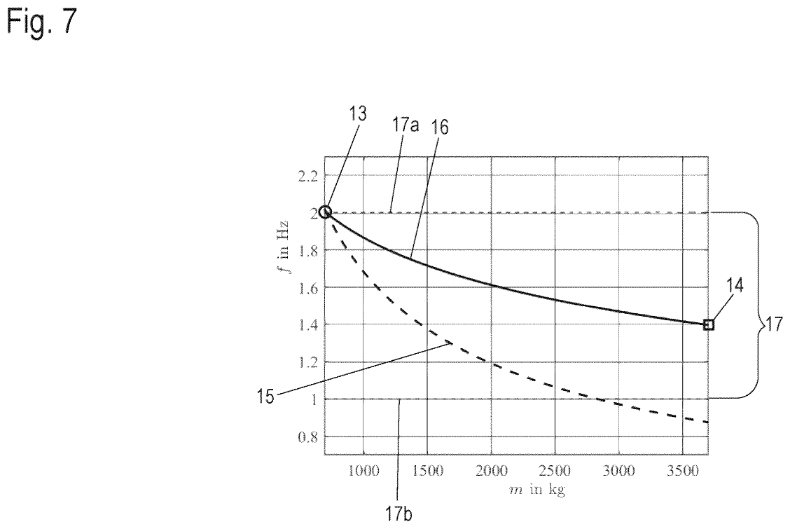

The overall spring stiffness kₜₒₜₐₗ is obtained by adding the spring characteristic curves 10, 11 (see FIG. 7) of the first spring 2 (k_{PSE}) and of the second spring 3 (k_{NSE}). This will be described in more detail below in conjunction with FIG. 6.

FIG. 6 shows a diagram with spring characteristic curves 10, 11, 12 of the spring assembly 1 for one of the suspension struts of the associated vehicle.

The deflection u (translation direction) in m between the reference R and the bottom edge of the frame 4 (see FIGS. 1-2) is plotted on the X axis of the diagram. The payload F is plotted as a weight force in N on the Y axis.

The diagram shows a spring characteristic curve 10 of the first spring 2 having the constant stiffness k_{PSE}, a spring characteristic curve 11 of the second spring 3 having the non-linear stiffness k_{NSE}, and a progressive spring assembly characteristic curve 13 of the spring assembly 1 having the overall stiffness kₜₒₜₐₗ.

In the unloaded condition of the vehicle or of the utility vehicle, the spring assembly 1 is preloaded by the mass of the chassis 8 (see FIG. 1, 3, 4). This is marked by a loading point 13 on the spring assembly characteristic curve 13.

In the loaded condition, the spring assembly 1 is acted on not only by the chassis 8 but also by the weight force F of the payload 9 (see FIG. 2, 5). This condition is indicated on the spring assembly characteristic curve 13 by the loading point 14.

FIG. 7 shows a diagram of a curve of the resulting natural frequency f as a function of the vehicle mass per suspension strut m of the associated vehicle/utility vehicle. Here, the natural frequency f is plotted in Hz versus the vehicle mass in kg.

Also plotted in the diagram is a frequency band 17 having an upper band limit 17a with the limit frequency 2 Hz (upper limit value) and having a lower band limit 17b with the limit frequency 1 Hz (lower limit value).

The natural frequency of a linear suspension assembly, which is shown here by a spring assembly characteristic 15, is reduced by a factor of 2 with increasing payload and thus with increasing vehicle mass m. Here, in the region of a vehicle mass m of approximately 3870 kg, the spring assembly characteristic curve 15 departs from the frequency band 17, crosses the lower band limit of 1 Hz, and continues onward to lower values lower than 1 Hz.

By contrast, the non-linear spring assembly characteristic curve 16 of the spring assembly 1 according to the invention has a much flatter extent, and remains in the frequency band 17 with increasing vehicle mass. In other words, the non-linear spring assembly characteristic curve 16 of the spring assembly 1 according to the invention results in a reduced frequency drop and thus ensures that the prescribed frequency band 17 of 1 Hz to 2 Hz is adhered to.

The vehicle dynamic requirement for an approximately constant natural frequency independently of the vehicle payload is thus satisfied. For this purpose, the spring assembly 1 has the non-linear or progressive spring assembly characteristic curve 12 or 16. Proceeding from a low stiffness level in the unloaded condition, the spring stiffness increases with increasing payload of the vehicle or with increasing compression of the springs. The progressive rise of the spring assembly characteristic curve 12 or 16 thus compensates for the influence of the increasing vehicle mass m, resulting in an approximately constant level of the natural frequency f of the associated vehicle. By contrast, when a conventional suspension arrangement having a linear spring characteristic curve or constant stiffness is used, the natural frequency f decreases significantly with increasing vehicle mass, as is illustrated by the spring assembly characteristic curve 15 for the conventional suspension arrangement.

In an embodiment which is not shown but is easily conceivable, the at least one second spring having a non-linear stiffness has regions with and without a negative stiffness. Here, the stiffness changes from negative to positive depending on the load condition, thus generating a non-linear characteristic curve. Such a spring embodiment is formed by means of a linear spring in combination with a non-linear spring element or a plurality of non-linear spring elements.

The non-linear spring concept of the spring assembly 1 having a non-linear spring stiffness thus offers the advantage of a natural frequency f that is virtually independent of payload. It is also a passive suspension concept, by contrast to air suspension, which requires active control for the purposes of adapting the air pressure and the stiffness of the suspension arrangement to the load condition.

The invention is not limited to the exemplary embodiment specified above, but may be modified within the scope of the claims.

List of reference signs

| | |
|---|---|
| Suspension assembly | 1 |
| First spring | 2 |
| Spring element | 2a |
| Second spring | 3 |
| Spring element | 3a, 3b |
| Frame | 4 |
| Frame articulation | 4a, 4b, 4b |
| Projection | 4d |
| Plate | 5 |
| Plate articulation | 5a, 5b |
| Projection | 5c |
| Wheel suspension | 6 |
| Vehicle wheel | 7 |
| Chassis | 8 |
| Payload | 9 |
| Spring characteristic curve | 10, 11 |
| Spring assembly characteristic curve | 12 |
| Loading point | 13, 14 |
| Spring assembly characteristic curve | 15, 16 |
| Frequency band | 17 |
| Band limit | 17a, 17b |
| Gravitational acceleration | g |
| Spring stiffness | k |
| Payload | F |
| Natural frequency | f |
| Vehicle mass | m |
| Reference | R |
| Deflection | u |

1.-13. (canceled)

14. A spring assembly for a vehicle, comprising:
at least one first spring; and
at least one second spring, wherein the first and second springs are arranged in a parallel configuration, and
wherein the spring assembly is configured as a non-linear spring assembly having a progressive spring characteristic curve.

15. The spring assembly as claimed in claim 14, further comprising:
a frame and a plate, wherein
the spring assembly is arranged in the frame which is movable in a translation direction along a deflection relative to the plate, and
the plate is guided in the frame so as to be movable in the translation direction.

16. The spring assembly as claimed in claim 15, wherein
the at least one first spring of the spring assembly has at least one spring element, and
the at least one second spring has two spring elements.

17. The spring assembly as claimed in claim 16, wherein
the at least one first spring of the spring assembly has a constant spring stiffness (k_{PSE}), and
the at least one second spring has a non-linear spring stiffness (k_{NSE}).

18. The spring assembly as claimed in claim 17, wherein
the at least one second spring having the non-linear spring stiffness has regions with and without negative stiffness.

19. The spring assembly as claimed in claim 16, wherein
the at least one spring element of the at least one first spring having the constant spring stiffness is articulated on the frame at one spring end, and
the other spring end of the at least one spring element is attached to the plate.

20. The spring assembly as claimed in claim 19, wherein
the at least one second spring having a non-linear spring stiffness is constructed from two spring elements which are arranged as a pair and so as to be inclined with respect to a translation direction extending in the direction of gravitational acceleration.

21. The spring assembly as claimed in claim 20, wherein
a first end of the first spring element of the at least one second spring is fastened to a projection protruding from an inner top wall of the frame,
a first end of the second spring element of the at least one second spring is articulated on an inner side wall of the frame, and
the two spring elements of the at least one second spring are articulated, by way of their other spring ends brought together at a common articulation point, on the plate.

22. The spring assembly as claimed in claim 21, wherein
the common articulation point of the other spring ends of the two spring elements of the at least one second spring is attached to a projection protruding from the plate.

23. The spring assembly as claimed in claim 21, wherein
the first ends of the first and second spring elements of the at least one second spring lie in a common plane, wherein said plane extends at right angles to the translation direction.

24. A suspension strut of a vehicle, comprising:
a frame;
a plate which is guided movably in the frame; and
a spring assembly as claimed in claim 14.

25. The suspension strut as claimed in claim 24, wherein
the frame is connected to a chassis of an associated vehicle, and
the plate is fastened to a wheel suspension of a vehicle wheel of the associated vehicle.

26. The suspension strut as claimed in claim 25, wherein
the plate is guided in the frame so as to be movable in a translation direction, and
the translation direction extends along a deflection (u) in the direction of gravitational acceleration.
